(19) United States
(12) Patent Application Publication
(10) Pub. No.: US 2010/0181752 A1
(43) Pub. Date: Jul. 22, 2010

(54) SKETCHBOOK SPINE CONSTRUCTION

(76) Inventor: ARTHUR VENDITTI, Peabody, MA (US)

Correspondence Address: LADAS & PARRY LLP, 26 WEST 61ST STREET, NEW YORK, NY, 10023, US

(21) Appl. No.: 12/354,865

(22) Filed: Jan. 16, 2009

(51) Int. Cl. B42D 3/00

(52) U.S. Cl. 281/34

(57) ABSTRACT

A removable spine for a book having pages bound together by a binder coil includes a base supporting a pair of spaced arms, the base and arms being of a length generally corresponding to a height of the binder book. The base has a width substantially equal to a width of the binder coil, while each of the arms joined together have a distal portion oriented to engage a portion of an outer surface of the book and a proximal portion in a clearance orientation with respect to the binder coil. The spine may be slid over the coil for mounting on the book, and may be easily removed from the book. The arms may be pivotally affixed to the base to allow the book to be opened with the spine in place.

The present invention relates to the field of book and binders, and more particularly to a novel and improved binder for labeling and organizing binder-type books.

### BACKGROUND OF THE INVENTION

Binder-type books are of a general form in which individual pages, with or without cover sheets, are joined or bound together by a coil or coils of wire extending through punched apertures extending along an edge of the pages. A typical construction for such a binder book is shown in FIG. 1. Such book constructions are commonly used for sketchbooks, photo albums, scrapbooks and the like. The wire binding may consist of a plurality of individual coils or a continuous spiral coil. Other variants of such binding may, for example, comprise a plastic spine element having a plurality of circular tabs or prongs that extend through the page apertures.

Often a user maintains a plurality of such books or binders, representing separate themes or subjects. For example, the user may have a plurality of scrapbooks, each directed to a particular event, such as birthday remembrances for a child. Similarly, the user may assemble a plurality of photo albums, each representing memories of a particular trip or vacation. Thus the user can accumulate a large number of such books.

The presence of such spiral bindings raises both organizational and aesthetic concerns. The wires (or tabs) are unattractive and preclude the effective placing of identifying indicia along the spine of the book, making identification of the binder and its contents unwieldy when the books are stacked on a shelf or the like in a normal fashion with the spines facing outwardly. The wires are also unattractive, and can inter-engage with the wires of adjacent books when stacked.

It is accordingly a purpose of the present invention to provide a binder for wire-bound books, such as sketchbooks, scrapbooks, and the like which allows such books to be stacked and stored in a manner whereby informational indicia can be located at the spine for effective identification.

A further purpose of the present invention is to provide a spine construction for wire-bound books which may be easily mounted to and removed from the book, is of economical construction, and which may be adapted to a variety of book sizes.

### BRIEF DESCRIPTION OF THE INVENTION

In accordance with the foregoing objects and purposes, a book spine in accordance with the present invention comprises a generally U-shaped element having an overall length compatible with the height of the book with which it is to be used. The opposed arms of the construction have distal portions adapted to grip the external faces of the book sheets inwardly of the wire binding, and proximal portions contoured to avoid interference with the binding. The arms are joined together by a central or base portion lying generally parallel to the book edge. Means may be provided on the central portion to accommodate informational indicia, such as a label, allowing the user to identify the contents of the book to which the binder is applied. The binder may be preferably formed as a plastic extrusion with sufficient flexibility to allow the binder to be inserted onto the book from behind the binder, the arms flexing as necessary to allow the distal ends to pass over the wire binder and subsequently grip the pages.

### BRIEF DESCRIPTION OF THE DRAWINGS

A fuller understanding of the present invention will be accomplished upon consideration of the following detailed description of a preferred but nonetheless illustrative embodiment of the invention, when reviewed in conjunction with the annexed figures wherein:

FIG. 1 is a perspective view of an illustrative bound book as know in the art with which the present invention can be utilized;

FIG. 2 is a perspective view of the book of FIG. 1 with the binder of the present invention mounted thereof;

FIG. 3 is a top plan view of the binder; and

FIG. 4 is an end elevation view of the book and binder combination as shown in FIG. 2.

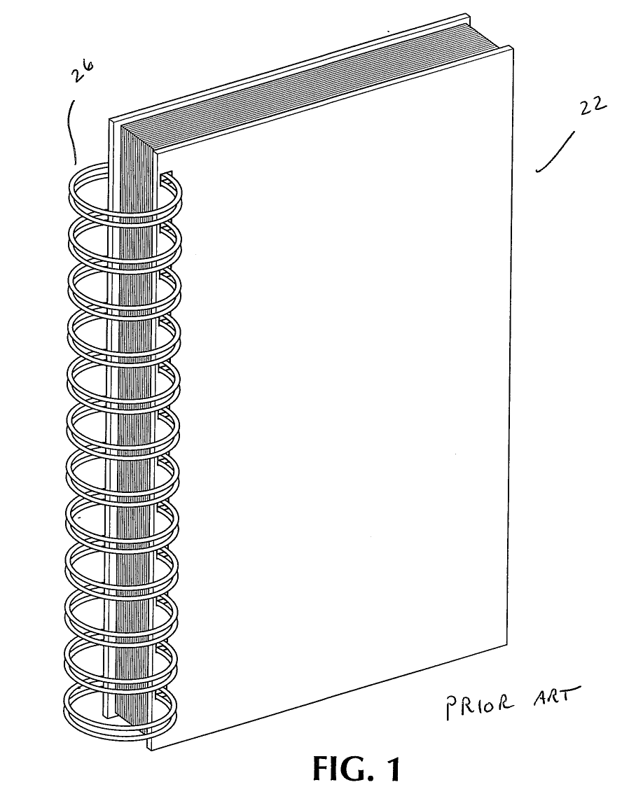

### DETAILED DESCRIPTION OF THE INVENTION

As depicted in the figures, binder 10 is in the form of an elongated, generally U-shaped extrusion having first and second generally parallel arms 12 extending from and joined to base portion 14. The extrusion may be, for example, of plastic, having a typical wall thickness of in the range of 0.080 inch, providing a generally rigid construction but with sufficient flex to allow the spine to be installed upon or removed from the book. The distal portions 16 of the arms 12 are configured to be parallel when the binder is installed upon a book, and are formed with small inwardly directed end protuberances 18 along their lengths, providing a contact surface between the binder 10 and the opposed outwardly-lying faces 20 of the exterior pages or covers of the book 22 to which the binder is mounted.

The proximal portions 24 of the arms are of an outwardly curved or arcuate construction so as to remain clear of the wire loops 26 of the book when the binder is installed. Both the distal and proximal portions 16, 24 of the arms may be provided with a series of vertically extending serrations or grooves 28 which both may improve the flexibility of the arms as well as providing an improved gripping surface for the arms by the user during spine mounting or removal.

The spine base 14 may be generally planar, oriented generally perpendicular to the arms 12 and accordingly lying parallel to the rear edge of the book, and may be provided with a card holder 30 to accommodate a sheet-like insert for carrying informational indicia or the like to be associated with the book upon which the spine is mounted. The cardholder may be of conventional construction as known in the art, mounted to the base 14 by a pair of rivets 32. Alternatively, the generally flat exterior face of base 14 provides a surface upon which identifying labeling or other indicia may be directly placed.

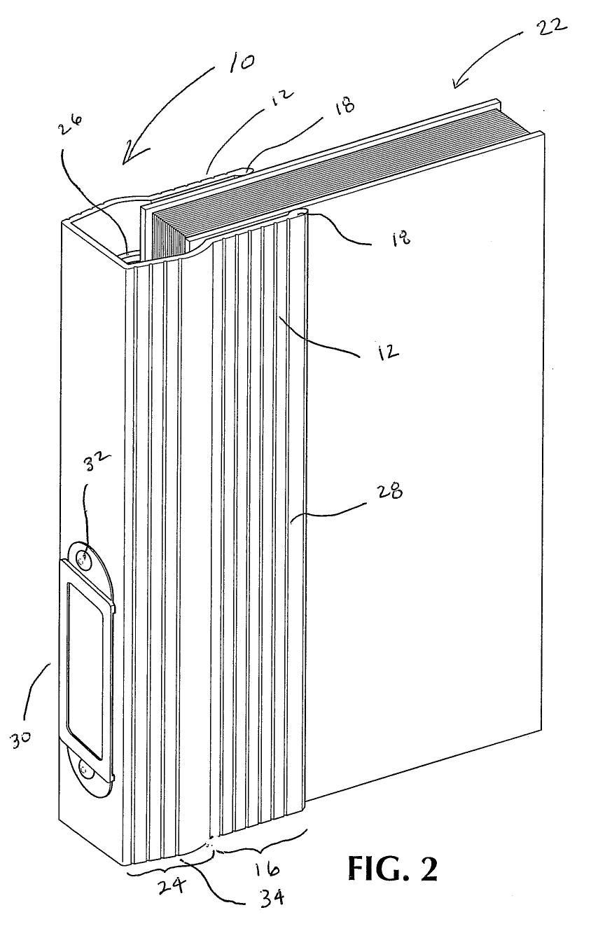

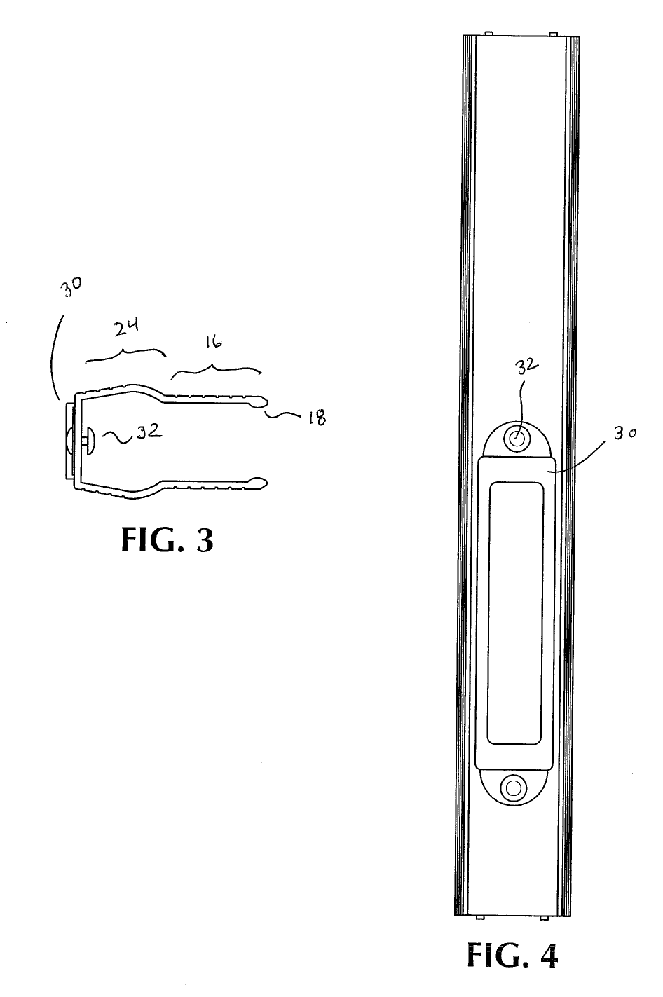

The binder 10 may be placed on a book 22 by either pressing it in place from the spine in direction A as depicted in FIG. 2, whereby the distal portion 16 of the arms flex outwardly as they ride over the wire loops 16 and subsequently come to bear against the exterior book faces 20 through contact therewith by the protuberances 18. Alternatively, the binder may be slid vertically along the spine, such as downwardly in direction B as shown in FIG. 2, whereby the wire loops 26 are immediately located between the widened, proximal portions 24 of the arms.

In a preferred embodiment of the binder, the spine arms, bearing against the book pages, secures the book in a closed orientation, the spine being removed from the book when the book is to be opened. In an alternative embodiment, however, the arms may be provided with sufficient flexibility to allow the distal portions to pivot outwardly to allow the binder to remain on the book when the book is opened. As depicted in FIG. 2, groove 34 in the proximal portion of the arm may be sufficient to allow the distal arm portion, as well as the portion of the proximal arm portion located to the right of the groove, to pivot. Preferably the groove 34 is aligned with or is rearward of the book pages inner vertical edges. In such a construction it is contemplated that the base and the portions of the proximal arm portion to the left of the groove 34 will be of a more substantial and rigid construction to ensure that, as the book is opened, the distal portions of the arms alone pivot with respect to the base and proximal portions, whereby the binder can remain in place on the book as it is opened.

I claim:

1. A removable spine for a book having pages bound together by a binder coil, comprising:
a base supporting a pair of spaced arms, the base and arms being of a length generally corresponding to a height of the binder book;
the base having a width substantially equal to a width of the binder coil;
each of the arms having a distal portion oriented to engage a portion of an outer surface of the book and a proximal portion in a clearance orientation with respect to the binder coil.

2. The spine of claim 1 wherein the arms have inwardly-extending protuberances to engage the outer surfaces of the book.

3. The spine of claim 1 further comprising pivot means to allow the distal portions to pivot outwardly with respect to at least a portion of the proximal portions.

4. The spine of claim 5 wherein the pivot means are at locations aligned with or rearward of inner vertical edges of the book pages.

5. The spine of claim 4 wherein the proximal portions of the arms are of a construction that maintains a substantially fixed relationship therebetween when the distal portions are pivoted outwardly from the book pages.

6. The spine of claim 1 wherein the proximal arm portions are constructed to allow a flexure thereof to ride over the binder coil when the spine is mounted on the book.

7. The spine of claim 1 further comprising indicia mounting means located on the base.
